(19) United States
(12) Patent Application Publication
(10) Pub. No.: US 2018/0182344 A1
(43) Pub. Date: Jun. 28, 2018

(54) DISPLAY DRIVING CIRCUIT AND LIQUID CRYSTAL DISPLAY (LCD) PANEL THEREOF

(71) Applicant: SHENZHEN CHINA STAR OPTOELECTRONICS TECHNOLOGY CO. LTD., SHENZHEN (CN)

(72) Inventor: JIANG ZHU, GUANGDONG (CN)

(21) Appl. No.: 15/313,930

(22) PCT Filed: Jul. 12, 2016
(86) PCT No.: PCT/CN2016/089718

§ 371 Date: Nov. 23, 2016

(30) Foreign Application Priority Data
Jun. 22, 2016 (CN) 201610457118.6

(51) Int. Cl. G09G 3/36

(52) U.S. Cl. CPC G09G 3/3685; G09G 2330/021; G09G 2340/0435; G09G 2320/0626; G09G 2320/0285

(57) ABSTRACT

The present invention provides a display driving circuit. The display driving circuit includes a conversion module, a selecting module and a frame control module. The conversion module digitally converts an original data signal and generates a first display data signal and a second display data signal. The selecting module selects either the first display data signal or the second display data signal to be a corresponding data line signal based on a pixel brightness configuration of the display panel. The frame control module enhances the data line signal of a frame operation.

### BACKGROUND OF THE INVENTION

### Field of Invention

The present invention relates to a technical field of a liquid crystal display (LCD), and more particularly to a display driving circuit and LCD panel thereof.

### Description of Prior Art

A display driving circuit of a conventional LCD panel usually includes a timing control module, an over-driving module, a white balance module and a data conversion module. An adjustment of the white balance is for an adaptation of the subjective sensation of many different users, where the data having 8-bit is converted into 12-bit for adjusting the display percentage of red, green and blue colors within a white gray level display frame and finely tuning the brightness of gray levels of white color such that all of the display frame is compatible to the requirement of Gamma 2.2.

However, due to a characteristic of an optical anisotropy in crystals of the LCD, the LCD has a color washout at a large viewing angle. In other words, the user will see the display frame with a color distortion in the large viewing angle, thereby down grading the viewing effect of the LCD at the large viewing angle.

The conventional LCD adopts a liquid crystal pixel having a multi-domain structure technique. In other words, a pixel unit is divided into a plurality of display units with a smaller size each. The driving voltage of main pixels and sub-pixels of the display units maintains a predetermined ratio such that the tilt angles of the liquid crystal molecules of each display unit are different to reduce the color washout of the LCD.

However, since the LCD panel having the multi-domain structure has a low transmittance rate, it is required to increase the operation power of the backlight light to meet the brightness requirement of the LCD, thereby increasing a large power consumption and manufacturing cost of the LCD.

Consequently, there is a need to develop a display driving circuit and LCD panel to solve the problems of the conventional technique.

### SUMMARY OF THE INVENTION

The display driving circuit and LCD panel thereof of the present invention can reduce the power consumption and manufacturing cost of the LCD panel to solve the problems of the increasing power consumption and manufacturing cost of the conventional LCD.

The present invention provides a display driving circuit to provide a plurality of data signals to a display panel. The display driving circuit includes:

a conversion module, digitally converting an original data signal and generating a first display data signal of main pixels and a second display data signal of sub-pixels by a look-up table based on the digitally converted data signal;

a selecting module, selecting either the first display data signal or the second display data signal to be a corresponding data line signal based on a pixel brightness configuration of the display panel; and

a frame control module, enhancing the data line signal of a frame operation by controlling a frame rate of the display panel.

In one embodiment of the display driving circuit, the data line signals of adjacent pixel units correspond to different kinds of the display data signals.

In one embodiment of the display driving circuit, the first display data signal is a display data signal having a high brightness and the second display data signal is a display data signal having a low brightness.

In one embodiment of the display driving circuit, the second display data signal is a display data signal having a high brightness and the first display data signal is a display data signal having a low brightness.

In one embodiment of the display driving circuit, the data signal is a data signal with a red color, a data signal with a blue color, and a data signal with a green color.

In one embodiment of the display driving circuit, the data signal is a data signal with a red color, a data signal with a blue color, a data signal with a green color, and a data signal with a white color.

The present invention provides a display driving circuit to provide a plurality of data signals to a display panel. The display driving circuit includes:

a conversion module, digitally converting an original data signal and generating a first display data signal of main pixels and a second display data signal of sub-pixels based on the digitally converted data signal;

a selecting module, selecting either the first display data signal or the second display data signal to be a corresponding data line signal based on a pixel brightness configuration of the display panel; and

a frame control module, enhancing the data line signal of a frame operation by controlling a frame rate of the display panel.

In one embodiment of the display driving circuit, the conversion module generates the first display data signal and the second display data signal by a look-up table.

In one embodiment of the display driving circuit, the first display data signal is a display data signal having a high brightness and the second display data signal is a display data signal having a low brightness.

In one embodiment of the display driving circuit, the second display data signal is a display data signal having a high brightness and the first display data signal is a display data signal having a low brightness.

In one embodiment of the display driving circuit, the data line signals of adjacent pixel units correspond to different kinds of the display data signals.

In one embodiment of the display driving circuit, the data signal is a data signal with a red color, a data signal with a blue color, and a data signal with a green color.

In one embodiment of the display driving circuit, the data signal is a data signal with a red color, a data signal with a blue color, a data signal with a green color, and a data signal with a white color.

The present invention provides a liquid crystal display (LCD) panel including a display panel and a display driving circuit to provide a plurality of data signals to the display panel. The display driving circuit includes:

a conversion module, digitally converting an original data signal and generating a first display data signal of main pixels and a second display data signal of sub-pixels based on the digitally converted data signal;

a selecting module, selecting either the first display data signal or the second display data signal to be a corresponding data line signal based on a pixel brightness configuration of the display panel; and

a frame control module, enhancing the data line signal of a frame operation by controlling a frame rate of the display panel.

In one embodiment of the LCD panel, the conversion module generates the first display data signal and the second display data signal by a look-up table.

In one embodiment of the LCD panel, the first display data signal is a display data signal having a high brightness and the second display data signal is a display data signal having a low brightness.

In one embodiment of the LCD panel, the second display data signal is a display data signal having a high brightness and the first display data signal is a display data signal having a low brightness.

In one embodiment of the LCD panel, the data line signals of adjacent pixel units correspond to different kinds of the display data signals.

In one embodiment of the LCD panel, the data signal is a data signal with a red color, a data signal with a blue color, and a data signal with a green color.

In one embodiment of the LCD panel, the data signal is a data signal with a red color, a data signal with a blue color, a data signal with a green color, and a data signal with a white color.

In comparison to the conventional display driving circuit and LCD panel, the display driving circuit and LCD panel thereof utilizes the conversion module of the display driving circuit to generate the first display data signal and the second display data signal. There is no need to configure a multi-domain structure on the LCD panel, thereby reducing the power consumption and manufacturing cost of the LCD to solve the problems of the increasing power consumption and manufacturing cost of the conventional LCD panel.

### BRIEF DESCRIPTION OF THE DRAWINGS

The following embodiments refer to the accompanying drawings for exemplifying specific implementable embodiments of the present invention. The drawings are only some embodiments of the present invention. Persons skilled in the art should be noted that other accompanying drawings can be obtained on the basis of the above-depicted drawings.

FIG. 1 is a schematic block diagram of a display driving circuit according to a first preferred embodiment of the present invention;

FIG. 2 is a schematic block diagram of a circuit of the display driving circuit according to the first preferred embodiment of the present invention; and

FIG. 3 is a schematic block diagram of a display driving circuit according to a second preferred embodiment of the present invention.

### DETAILED DESCRIPTION OF THE PREFERRED EMBODIMENTS

In the drawings, the same reference symbol represents the same or a similar component. The foregoing preferred embodiments of the present invention are illustrative rather than limiting of the present invention.

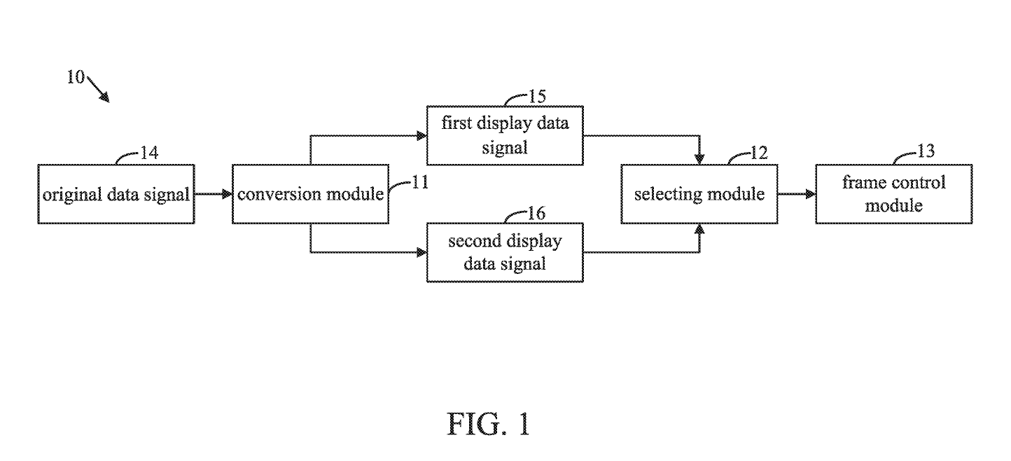

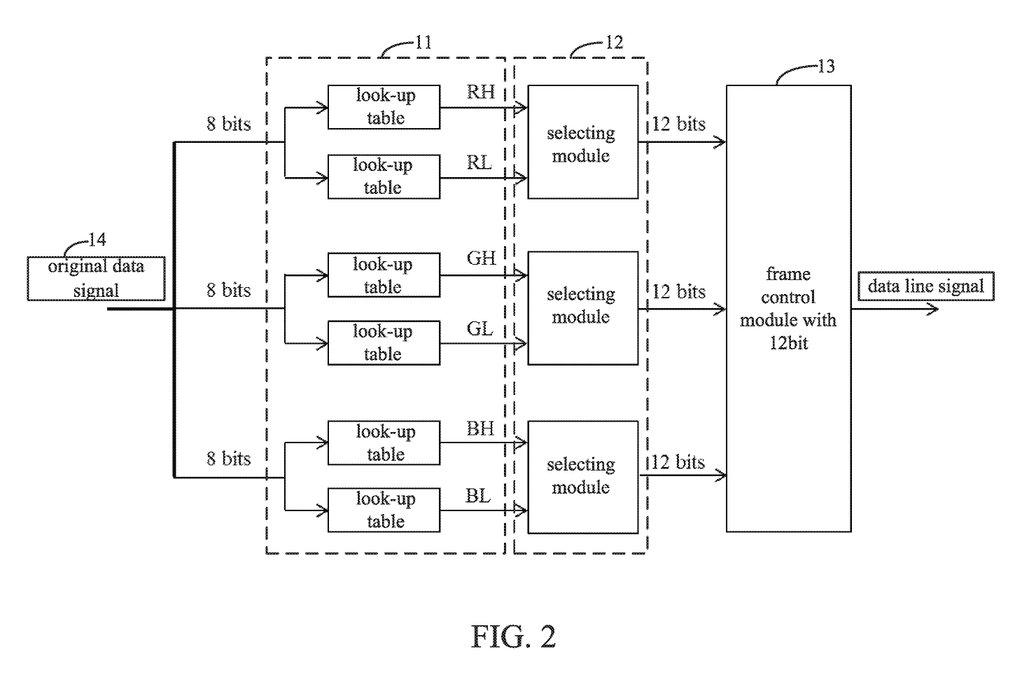

FIG. 1 is a schematic block diagram of a display driving circuit according to a first preferred embodiment of the present invention. FIG. 2 is a schematic block diagram of an electrical circuit of a display driving circuit 10 according to the first preferred embodiment of the present invention. The display driving circuit 10 provides the data signals to the LCD panel and includes a conversion module 11, a selecting module 12, and a frame control module 13.

The conversion module 11 is configured to digitally convert an original data signal 14 and generates a first display data signal 15 of the main pixels and a second display data signal 16 of sub-pixels based on the digitally converted data signal. The selecting module 12 selects the first display data signal 15 or second display data signal 16 to be corresponding data line signal based on a pixel brightness configuration of display panel. The frame control module 13 is configured to enhance the data line signal of frame operation by controlling a frame rate of the display panel.

In one embodiment, the first display data signal 15 of the display driving circuit 10 is a display data signal having a high brightness and the second display data signal 16 is a display data signal having a low brightness.

When the display driving circuit 10 operates, the conversion module 11 of the display driving circuit 10 digitally converts an original data signal. For example, the data signal having 8-bit is converted into a data signal having a 12-bit. In one case, the data signal is a data signal with a red color (R), a data signal with a blue color (B), and a data signal with a green color (G). In another case, the data signal is a data signal with a red color (R), a data signal with a blue color (B), a data signal with a green color (G), and a data signal with a white color (W).

Afterwards, the conversion module 11 generates the first display data signal 15 of the main pixels and the second display data signal 16 of the sub-pixels corresponding to each data signal by a look-up table. For example, the data signal with the red color R is converted into a first display data signal RH and a second display data signal RL. The data signal with the blue color B is converted into a first display data signal BH and a second display data signal BL. The data signal with the green color G is converted into a first display data signal GH and a second display data signal GL. The data signal with the white color W is converted into a first display data signal WH and a second display data signal WL.

The selecting module 12 then selects the first display data signal 15 or second display data signal 16 to be the corresponding data line signal based on the pixel brightness configuration of display panel. In order to solve the problem of color washout of the LCD, it is required to alternate the luminescence and brightness of the adjacent pixel units of the LCD panel. Thus, the data line signals of the adjacent pixel units of the LCD panel correspond to different kinds of display data signals.

Finally, the frame control module 13 is configured to enhance the data line signals, which are selected by the selecting module 12, of frame operation by a frame rate control of the display panel. The frame rate control means that the pixel chroma can be changed between a dark state and a bright state when the frame is switched to generate an intermediate chroma. For example, four frames can form three intermediate chromas, thereby reducing the manufacturing cost and increasing an image resolution.

Thus, the data signals of the display driving circuit 10 are completely generated.

In one embodiment of the present invention, the conversion module of the display driving circuit 10 generates the first display data signal and the second display data signal. There is no need to configure a multi-domain structure on the LCD panel, thereby reducing the power consumption and manufacturing cost of the LCD.

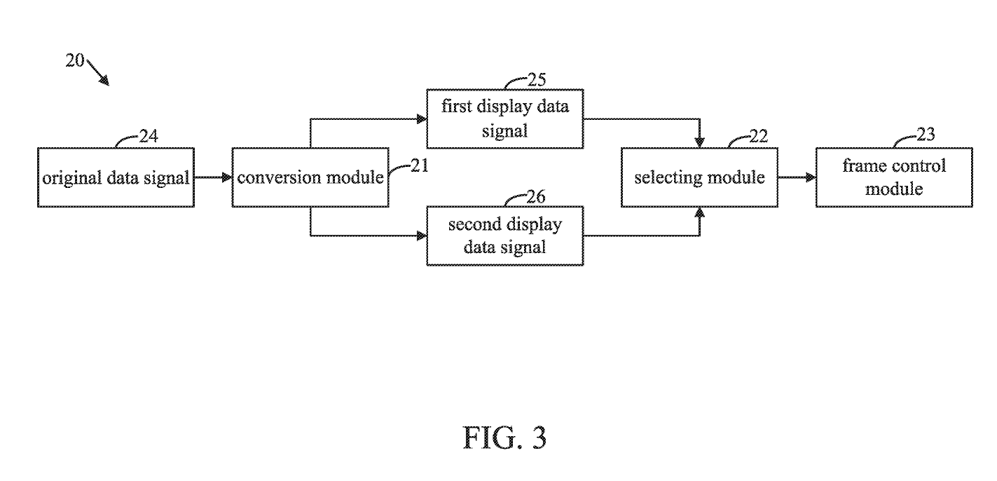

FIG. 3 is a schematic block diagram of a circuit of the display driving circuit according to the second preferred embodiment of the present invention. The display driving circuit 20 provides the data signals to the LCD panel and includes a conversion module 21, a selecting module 22, and a frame control module 23.

In one embodiment, the second display data signal 26 of the display driving circuit 20 is a display data signal having a high brightness and the first display data signal 25 is a display data signal having a low brightness.

When the display driving circuit 20 operates, the conversion module 21 of the display driving circuit 20 digitally converts an original data signal. For example, the data signal having 8-bit is converted into a data signal having a 12-bit. In one case, the data signal is a data signal with a red color (R), a data signal with a blue color (B), and a data signal with a green color (G). In another case, the data signal is a data signal with a red color (R), a data signal with a blue color (B), a data signal with a green color (G), and a data signal with a white color (W).

Afterwards, the conversion module 21 generates the first display data signal 25 of the main pixels and the second display data signal 26 of the sub-pixels corresponding to each data signal by a look-up table. For example, the data signal with the red color R is converted into a first display data signal RH and a second display data signal RL. The data signal with the blue color B is converted into a first display data signal BH and a second display data signal BL. The data signal with the green color G is converted into a first display data signal GH and a second display data signal GL. The data signal with the white color W is converted into a first display data signal WH and a second display data signal WL.

The selecting module 22 then selects the first display data signal 25 or second display data signal 26 to be the corresponding data line signal based on the pixel brightness configuration of display panel. In order to solve the problem of color washout of the LCD, it is required to alternate the luminescence and brightness of the adjacent pixel units of the LCD panel. Thus, the data line signals of the adjacent pixel units of the LCD panel correspond to different kinds of display data signals.

Finally, the frame control module 23 is configured to enhance the data line signals, which are selected by the selecting module 22, of the frame operation by a frame rate control of the display panel, thereby reducing the manufacturing cost and increasing an image resolution.

Thus, the data signals of the display driving circuit 20 are completely generated.

In one embodiment of the present invention, the conversion module of the display driving circuit 20 generates the first display data signal and the second display data signal. There is no need to configure a multi-domain structure on the LCD panel, thereby reducing the power consumption and manufacturing cost of the LCD.

The present invention further provides a LCD panel including a display panel and a display driving circuit to supply data signals to the display panel. The display driving circuit includes a conversion module, a selecting module, and a frame control module.

The conversion module is configured to digitally convert an original data signal and generates a first display data signal of the main pixels and a second display data signal of sub-pixels based on the digitally converted data signal. The selecting module selects the first display data signal or second display data signal to be corresponding data line signal based on a pixel brightness configuration of display panel. The frame control module is configured to enhance the data line signal of frame operation by controlling a frame rate of the display panel.

In one embodiment, the conversion module generates the first display data signal and the second display data signal corresponding to each data signal by a look-up table.

In one embodiment, the first display data signal is a display data signal having a high brightness and the second display data signal is a display data signal having a low brightness. In another case, the second display data signal is a display data signal having a high brightness and the first display data signal is a display data signal having a low brightness.

In one embodiment, the data line signals of the adjacent pixel units of the LCD panel correspond to different kinds of display data signals.

In one case, the data signal is a data signal with a red color, a data signal with a blue color, and a data signal with a green color. In another case, the data signal is a data signal with a red color, a data signal with a blue color, a data signal with a green color, and a data signal with a white color.

The operation theorem of the LCD panel in the present invent is the same as similar to the above-mentioned display driving circuit. Please refer to the aforementioned related descriptions of the display driving circuit.

The display driving circuit and LCD panel thereof utilizes the conversion module of the display driving circuit to generate the first display data signal and the second display data signal. There is no need to configure a multi-domain structure on the LCD panel, thereby reducing the power consumption and manufacturing cost of the LCD to solve the problems of the increasing power consumption and manufacturing cost of the conventional LCD panel.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structures.

What is claimed is:

1. A display driving circuit to provide a plurality of data signals to a display panel, the display driving circuit comprising:
a conversion module, digitally converting an original data signal and generating a first display data signal of main pixels and a second display data signal of sub-pixels by a look-up table based on the digitally converted data signal;
a selecting module, selecting either the first display data signal or the second display data signal to be a corresponding data line signal based on a pixel brightness configuration of the display panel; and
a frame control module, enhancing the data line signal of a frame operation by controlling a frame rate of the display panel.

2. The display driving circuit of claim 1, wherein the first display data signal is a display data signal having a high brightness and the second display data signal is a display data signal having a low brightness.

3. The display driving circuit of claim 1, wherein the second display data signal is a display data signal having a high brightness and the first display data signal is a display data signal having a low brightness.

4. The display driving circuit of claim 1, wherein the data signal is a data signal with a red color, a data signal with a blue color, and a data signal with a green color.

5. The display driving circuit of claim 1, wherein the data signal is a data signal with a red color, a data signal with a blue color, a data signal with a green color, and a data signal with a white color.

6. A display driving circuit to provide a plurality of data signals to a display panel, the display driving circuit comprising:
a conversion module, digitally converting an original data signal and generating a first display data signal of main pixels and a second display data signal of sub-pixels based on the digitally converted data signal;
a selecting module, selecting either the first display data signal or the second display data signal to be a corresponding data line signal based on a pixel brightness configuration of the display panel; and
a frame control module, enhancing the data line signal of a frame operation by controlling a frame rate of the display panel.

7. The display driving circuit of claim 6, wherein the conversion module generates the first display data signal and the second display data signal by a look-up table.

8. The display driving circuit of claim 6, wherein the first display data signal is a display data signal having a high brightness and the second display data signal is a display data signal having a low brightness.

9. The display driving circuit of claim 6, wherein the second display data signal is a display data signal having a high brightness and the first display data signal is a display data signal having a low brightness.

10. The display driving circuit of claim 6, wherein the data line signals of adjacent pixel units correspond to different kinds of the display data signals.

11. The display driving circuit of claim 6, wherein the data signal is a data signal with a red color, a data signal with a blue color, and a data signal with a green color.

12. The display driving circuit of claim 6, wherein the data signal is a data signal with a red color, a data signal with a blue color, a data signal with a green color, and a data signal with a white color.

13. A liquid crystal display (LCD) panel comprising a display panel and a display driving circuit to provide a plurality of data signals to the display panel, the display driving circuit comprising:
a conversion module, digitally converting an original data signal and generating a first display data signal of main pixels and a second display data signal of sub-pixels based on the digitally converted data signal;
a selecting module, selecting either the first display data signal or the second display data signal to be a corresponding data line signal based on a pixel brightness configuration of the display panel; and
a frame control module, enhancing the data line signal of a frame operation by controlling a frame rate of the display panel.

14. The LCD panel of claim 13, wherein the conversion module generates the first display data signal and the second display data signal by a look-up table.

15. The LCD panel of claim 13, wherein the first display data signal is a display data signal having a high brightness and the second display data signal is a display data signal having a low brightness.

16. The LCD panel of claim 13, wherein the second display data signal is a display data signal having a high brightness and the first display data signal is a display data signal having a low brightness.

17. The LCD panel of claim 13, wherein the data line signals of adjacent pixel units correspond to different kinds of the display data signals.

18. The LCD panel of claim 13, wherein the data signal is a data signal with a red color, a data signal with a blue color, and a data signal with a green color.

19. The LCD panel of claim 13, wherein the data signal is a data signal with a red color, a data signal with a blue color, a data signal with a green color, and a data signal with a white color.
